(19) United States
(12) Patent Application Publication
(10) Pub. No.: US 2022/0383432 A1
(43) Pub. Date: Dec. 1, 2022

(54) RECOMMENDED ACTION OUTPUT SYSTEM, RECOMMENDED ACTION OUTPUT METHOD, AND RECORDING MEDIUM

(71) Applicant: Panasonic Intellectual Property Management Co., Ltd., Osaka (JP)

(72) Inventors: Kotaro SAKATA, Osaka (JP); Fuminori IKUTA, Shiga (JP)

(21) Appl. No.: 17/885,708

(22) Filed: Aug. 11, 2022

Related U.S. Application Data
(63) Continuation of application No. PCT/JP2021/002289, filed on Jan. 22, 2021.

(30) Foreign Application Priority Data
Feb. 27, 2020 (JP) 2020-032397

(51) Int. Cl. G06Q 50/06; B60L 58/12; B60L 53/63; B60L 53/62; H02J 3/00; G06Q 30/02

(52) U.S. Cl. CPC G06Q 50/06; B60L 58/12; B60L 53/63; B60L 53/62; H02J 3/003; G06Q 30/0202

(57) ABSTRACT

A recommended action output system includes a communicator that obtains activity plan information including an activity plan of a user of a vehicle including a storage battery and electricity storage information including electricity storage capacity of the storage battery and an amount of electricity stored currently in the storage battery; a controller that obtains charger information including locations of vehicle chargers in a specific area; a predictor that predicts a change over time in electric power demand in the specific area; a determiner that determines a charging timing of the storage battery recommended to the user and a charging location indicating a location of a vehicle charger for charging the storage battery to reduce peak demand in the predicted change over time, based on the activity plan information, the electricity storage information, and the charger information; and a communicator that outputs recommendation information including the determined charging timing and location.

### CROSS REFERENCE TO RELATED APPLICATIONS

This is a continuation application of PCT International Application No. PCT/JP2021/002289 filed on Jan. 22, 2021, designating the United States of America, which is based on and claims priority of Japanese Patent Application No. 2020-032397 filed on Feb. 27, 2020. The entire disclosures of the above-identified applications, including the specifications, drawings and claims are incorporated herein by reference in their entirety.

### FIELD

The present disclosure relates to a recommended action output system, a recommended action output method, and a recording medium.

### BACKGROUND

In recent years, electrification has progressed in various fields, including the spread of all-electric homes and the introduction of electric vehicles, and is expected to accelerate further in the future. Such progress in electrification has led to concern about a possible increase in the load on systems that supply electric power. For example, an increase in the load for charging electric vehicles may upset the supply and demand balance of electric power and lower the quality of electric power in electric power grids.

In addressing this issue, Patent Literature (PTL) 1 discloses a charge controlling method that, in order to balance the supply and demand of electric power in an electric power grid, guides only a necessary number of electric vehicles to charging stations at necessary timings and thus controls the electric power for charging the electric vehicles at the charging stations.

### CITATION LIST

### Patent Literature

PTL 1: Japanese Unexamined Patent Application Publication No. 2012-48286

### SUMMARY

### Technical Problem

The technique according to PTL 1, however, has no consideration over user-friendliness for the users. Therefore, the technique according to PTL 1 may hinder user-friendliness for the users.

Accordingly, the present disclosure provides a recommended action output system, a recommended action output method, and a recording medium that can balance the supply and demand of electric power while maintaining user-friendliness for their users.

### Solution to Problem

A recommended action output system according to one aspect of the present disclosure includes: a first obtainer that obtains activity plan information including an activity plan of a user of a vehicle that includes a storage battery; a second obtainer that obtains electricity storage information including an electricity storage capacity of the storage battery of the vehicle and an amount of electricity stored currently in the storage battery; a third obtainer that obtains charger information including location of at least one vehicle charger installed in a specific area; a predictor that predicts a change over time in electric power demand in the specific area; a determiner that determines a charging timing of the storage battery to be recommended to the user and a charging location indicating a location of a vehicle charger for charging the storage battery so as to reduce peak demand in the change over time predicted in the electric power demand, based on the activity plan information, the electricity storage information, and the charger information; and an outputter that outputs recommendation information including the charging timing and the charging location determined.

A recommended action output method according to one aspect of the present disclosure includes: obtaining activity plan information including an activity plan of a user of a vehicle that includes a storage battery; obtaining electricity storage information including an electricity storage capacity of the storage battery of the vehicle and an amount of electricity stored currently in the storage battery; obtaining charger information including locations of a plurality of vehicle chargers installed in a specific area; predicting a change over time in electric power demand in the specific area; determining a charging timing of the storage battery to be recommended to the user and a charging location indicating a location of a vehicle charger for charging the storage battery so as to reduce peak demand in the change over time predicted in the electric power demand, based on the activity plan information, the electricity storage information, and the charger information; and outputting recommendation information including the charging timing and the charging location determined.

A recording medium according to one aspect of the present disclosure is a non-transitory computer-readable recording medium having a program recorded thereon, and the program causes a computer to execute the recommended action output method described above.

### Advantageous Effects

The recommended action output system and so forth according to some aspects of the present disclosure can balance the supply and demand of electric power while maintaining user-friendliness for their users.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a diagram illustrating an overview of an energy management system.

FIG. 2 is a graph illustrating some examples of diurnal variations in electric power demand.

FIG. 3 is a graph illustrating some examples of diurnal variations in actual electric power demand.

FIG. 4 is a block diagram illustrating a functional configuration of a recommended action output system according to one exemplary embodiment.

FIG. 5A is a table illustrating an example of activity plan information according to one exemplary embodiment.

FIG. 5B is a table illustrating an example of electricity storage information according to one exemplary embodiment.

FIG. 5C is a table illustrating an example of charger information according to one exemplary embodiment.

FIG. 6 is a flowchart illustrating an operation of a recommended action output system according to one exemplary embodiment.

FIG. 7 is a flowchart illustrating a first example of a process of determining a charging timing and a charging location indicated in FIG. 6.

FIG. 8 is a flowchart illustrating a second example of a process of determining a charging timing and a charging location indicated in FIG. 6.

FIG. 9 is a flowchart illustrating a third example of a process of determining a charging timing and a charging location indicated in FIG. 6.

FIG. 10 is a flowchart illustrating a fourth example of a process of determining a charging timing and a charging location indicated in FIG. 6.

FIG. 11 is a flowchart illustrating an example of a process of generating recommendation information indicated in FIG. 6.

### DESCRIPTION OF EMBODIMENTS

### Underlying Knowledge Forming Basis of the Present Disclosure

In recent years, challenges of conventional large-scale, centralized energy systems have become more apparent, and introduction of renewable energy has expanded. Such circumstances have promoted a shift to distributed energy systems that utilize relatively small-scale, locally dispersed energy resources. Moreover, distributed energy resources are becoming increasingly widespread among consumers—including cogeneration systems, such as photovoltaic power generation or household fuel cells; stationary storage batteries; electric vehicles; private power generation facilities; or megawatts (electric power saved). Examples of energy consumption on the consumer side include lighting devices, air conditioning devices, or heat pump water heaters installed in homes, or production facilities at factories.

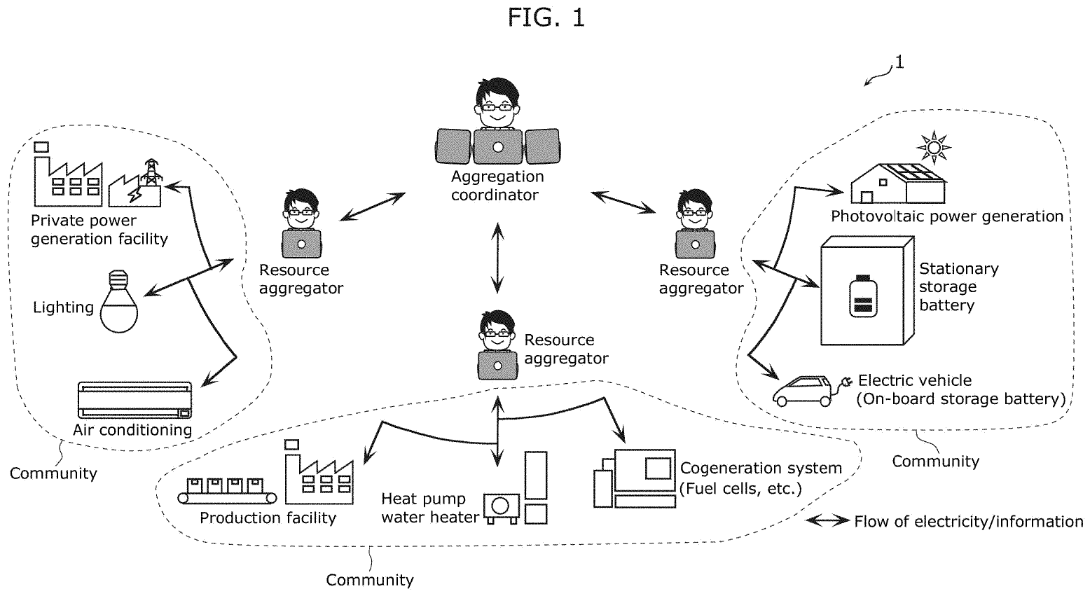

These distributed energy resources in homes or factories are each small in scale. Yet, a system or a concept called “virtual power plant (VPP)” is being proposed. In VPP, distributed energy resources in homes or factories are aggregated through advanced energy management technologies utilizing the Internet of Things (IoT) and controlled remotely and integrally. Thus, VPP is used to adjust the balance between the supply and demand of electric power and functions like a single power plant (see FIG. 1). FIG. 1 is a diagram illustrating an overview of energy management system 1.

As illustrated in FIG. 1, energy management system 1 is a system that, with a plurality of consumers forming one group (a community), collectively manages energy of a plurality of consumers for the purpose of, for example, reducing the amount of energy used by a community as a whole or effectively using renewable energy by a plurality of consumers. Energy management system 1 includes a community, a resource aggregator (an electric power aggregator), and an aggregation coordinator. The number of communities, resource aggregators, or aggregation coordinators included in energy management system 1 is not limited to the number shown in FIG. 1.

Each community includes a plurality of consumers. A resource aggregator and an aggregation coordinator are service providers that integrally control, for example, energy resources or distributed energy resources on the consumer side and provide an energy service from a virtual power plant (VPP). In other words, a resource aggregator and an aggregation coordinator are service providers that supply energy to a plurality of consumers. A resource aggregator is provided, for example, for each community and controls electric power used by a plurality of consumers in the community. Electric power and information are transmitted and received between a resource aggregator and a plurality of consumers. Herein, VPP integrally controls power generation facilities, energy resources, and so on dispersed over an electric power grid as if they function like a single power plant (a virtual power plant). An aggregation coordinator aggregates the amount of electric power controlled by a resource aggregator and trades electric power with so-called electric power companies such as electric power transmission and distribution companies or retail electricity providers.

Rapidly becoming popular in recent years are electric-powered vehicles, including electric vehicles, equipped with storage batteries (on-board storage batteries), which can also be used as energy resources in energy management systems 1 described above. An electric-powered vehicle refers to a vehicle that can run on electricity. An electric-powered vehicle includes a vehicle powered solely by electricity (a so-called electric vehicle: EV), a vehicle powered by electricity and other energy sources (e.g., fuels such as gasoline) (a so-called hybrid vehicle: HV), and a hybrid vehicle equipped with an external charging function (a so-called plug-in hybrid vehicle: PHV). A vehicle also refers to a machine that can travel on roads, and a vehicle includes, for example, a two-wheeled vehicle, a three-wheeled vehicle, or a four-wheeled vehicle. It is predicted that EVs in particular will spread rapidly in the future.

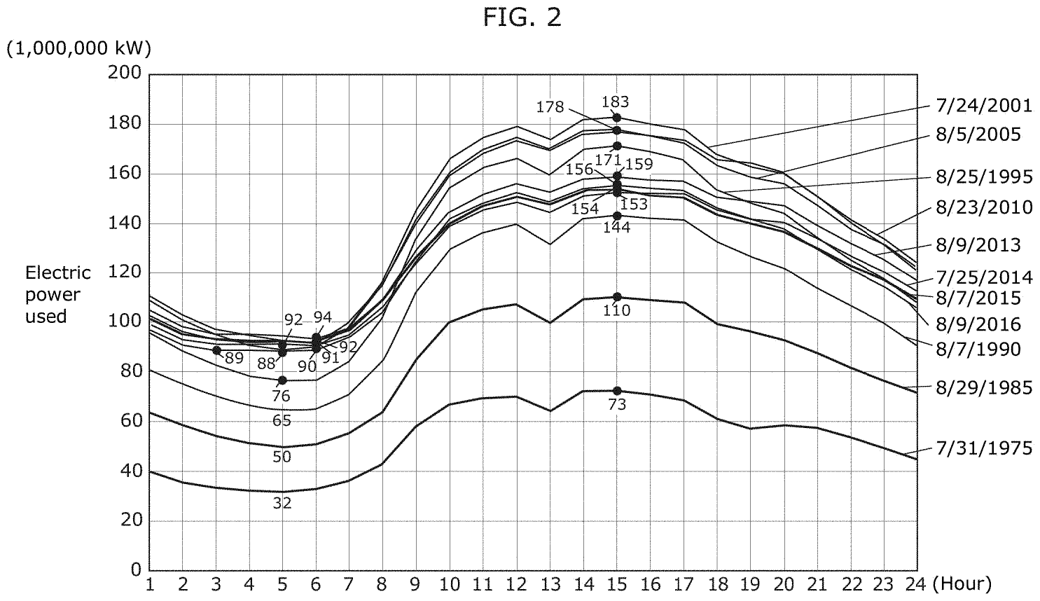

Now, variations in electric power demand will be described with reference to FIG. 2. FIG. 2 is a graph illustrating some examples of diurnal variations in electric power demand (source: The Federation of Electric Power Companies of Japan Website, accessed on Feb. 21, 2020, Internet <URL: https://www.fepc.or.jp/enterprise/jigyou/japan>. FIG. 2 is a graph illustrating examples of diurnal variations in electric power demand in some representative years from between 1975 and 2016.

As illustrated in FIG. 2, electric power demand increases during the daytime and reaches its peak demand in diurnal variations. For example, electric power demand reaches its peak demand in diurnal variations at around 15:00 (3:00 PM). Then, electric power demand starts to decrease around evening and reaches its minimum demand in the morning. For example, electric power demand reaches its minimum demand of diurnal variations at around 5:00.

In recent years, the number of customers owning natural energy-based power generation facilities, such as photovoltaic power generation facilities, is on the rise and is expected to grow continuously in the future. For example, photovoltaic power generation is a method of generating electricity by converting sunlight into electric power and generates electricity primarily during the daytime. Photovoltaic power generation can hardly generate electricity during the nighttime when it receives almost no sunlight.

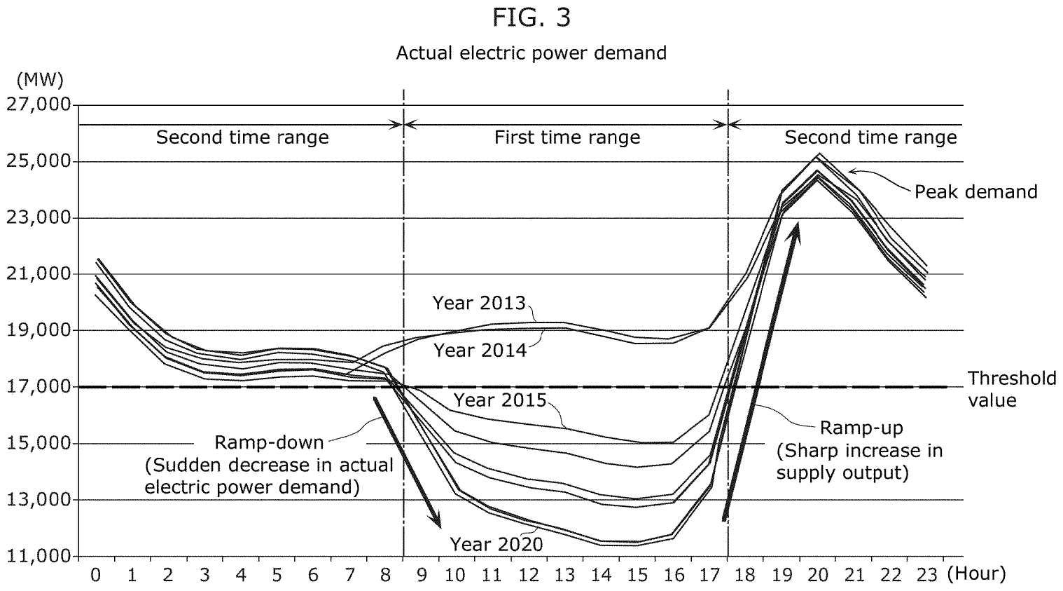

Actual electric power demand in energy management system 1 including such consumers will be described with reference to FIG. 3. FIG. 3 is a graph illustrating some examples of diurnal variations in actual electric power demand (source: Jonathan Coignard et al., 2018, Environmental Research Letters, California Independent System Operator). Herein, actual electric power demand is net electric power demand obtained by subtracting the amount of electric power generated at the consumers through, for example, photovoltaic power generation from the amount of electric power actually consumed. Actual electric power demand indicates the amount of electric power that the consumers in energy management system 1 need to be supplied with from electric power companies. FIG. 3 illustrates representative examples of diurnal variations in actual electric power demand in years from 2013 to 2020.

As illustrated in FIG. 3, actual electric power demand decreases greatly during the daytime when photovoltaic power generation generates a large amount of electricity, and the demand increases conversely after evening when the amount of electricity that photovoltaic power generation generates is small. This reversal of the supply and demand balance between the daytime and the evening is known as a duck curve phenomenon. During the daytime, electricity is generated by consumers through photovoltaic power generation or the like, and thus actual electric power demand decreases. Meanwhile, after the evening, actual electric power demand increases because the amount of electricity generated by consumers through photovoltaic power generation or the like decreases and the amount of electric power used by consumers increases as office workers and the like return home. This duck curve phenomenon is becoming more prominent over the years.

Such a duck curve phenomenon can lower the quality of electric power in electric power grids. Yet, in the future, actual electric power demand during the daytime is expected to decrease as more and more consumers own photovoltaic power generation facilities, and actual electric power demand in the evening and later hours is expected to increase as the number of electric-powered vehicles increases. For example, a case is described below where several dozen houses in a housing complex of several dozen to several hundred houses have EVs, where the housing complex has a plurality of charging stations that can charge EVs, and where the residents of the several dozen houses return home from work or the like in the evening or later. In this case, if the residents of these several dozen houses charge their EVs after returning home, this can produce a sharp increase in actual electric power demand in the evening or later at the housing complex.

If such a phenomenon occurs in each of the electric power grid systems, this can cause an even steeper ramp-up (a phenomenon in which the output of the supply increases sharply) in the evening. This means that the duck curve phenomenon becomes even more prominent and can further lower the quality of electric power in electric power grids. The duck curve phenomenon becoming prominent is undesirable from the standpoint of energy cost.

Therefore, the supply and demand of electric power need to be balanced even under the circumstances in which the amount of electricity generated by consumers increases and the number of electric-powered vehicles increases. A measure such as simply charging electric-powered vehicles during the daytime is not user-friendly because users have to go out to charge their electric-powered vehicles during the daytime. Accordingly, the inventors of the present application have diligently examined how to balance the supply and demand of electric power while maintaining user-friendliness for users and conceived of a recommended action output system and a recommended action output method described hereinafter. Balancing the supply and demand of electric power in the present application means, for example, reducing peak demand of actual electric power demand. In the case of the diurnal variations in actual electric power demand shown in FIG. 3, the supply and demand of electric power may be balanced by reducing peak demand of actual electric power demand in the evening and later.

The aforementioned charging station may be a charging and discharging station (e.g., EV Power Station (registered trademark)) that normally charges the secondary battery of an electric-powered vehicle and can also discharge the secondary battery of an electric-powered vehicle in an emergency situation when the electric power supply is interrupted due to an electric power grid blackout or the like to meet the electric power demand within a housing complex or the like.

Hereinafter, some exemplary embodiments will be described with reference to the drawings. The exemplary embodiments described below merely illustrate general or specific examples. The numerical values, the constituent elements, the steps, the orders of the steps, and so on illustrated in the following exemplary embodiment are examples and are not intended to limit the present disclosure.

The drawings are schematic diagrams and do not necessarily provide the exact depiction. In the drawings, substantially identical configurations are given identical reference characters, and duplicate description thereof may be omitted or simplified.

In the present specification, terms, such as “match”, expressing relationships between elements, the numerical values, and the numerical ranges are not to be construed only in their strict sense but to be construed to include substantially equal ranges—for example, differences of approximately several percentages.

### Embodiment

### [1. Configuration of Recommended Action Output System]

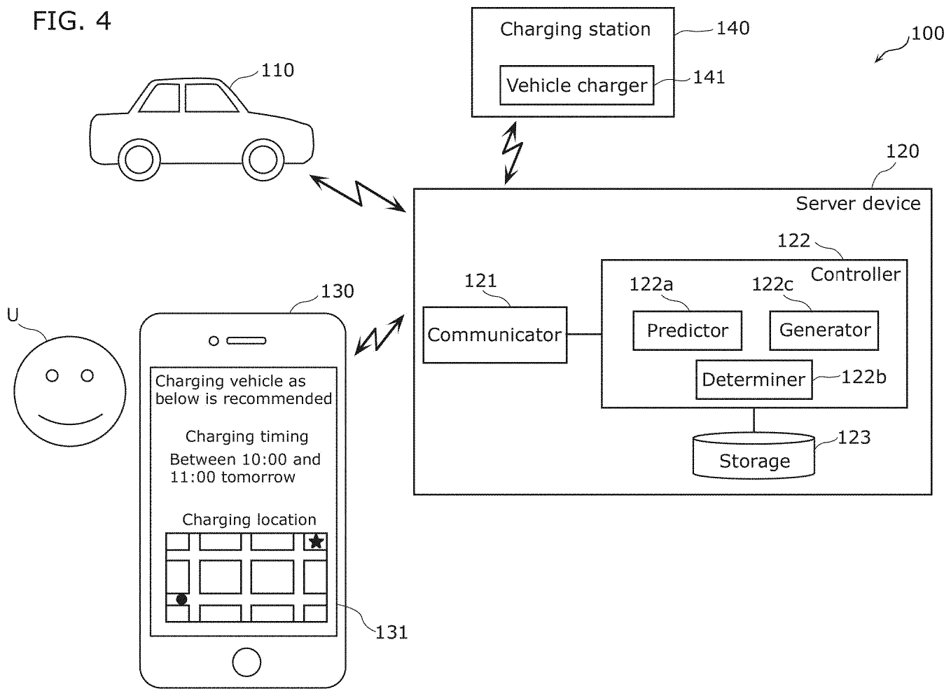

First, a configuration of a recommended action output system will be described with reference to FIG. 4. FIG. 4 is a block diagram illustrating a functional configuration of recommended action output system 100 according to the present embodiment.

As illustrated in FIG. 4, recommended action output system 100 includes vehicle 110, server device 120, information terminal 130, and charging station 140.

Vehicle 110 is an electric-powered vehicle used by user U. Vehicle 110 is an automobile or may be, for example, a taxi, a bus, or the like. Vehicle 110 includes a battery. The battery includes, for example, a plurality of secondary batteries. A secondary battery is, for example, a lithium-ion secondary battery, but this is not a limiting example, and a secondary battery may be any secondary battery that can be used in electric-powered vehicles, such as a nickel-hydrogen secondary battery. In the following description, a secondary battery is also referred to as a storage battery. User U is an example of a user of vehicle 110.

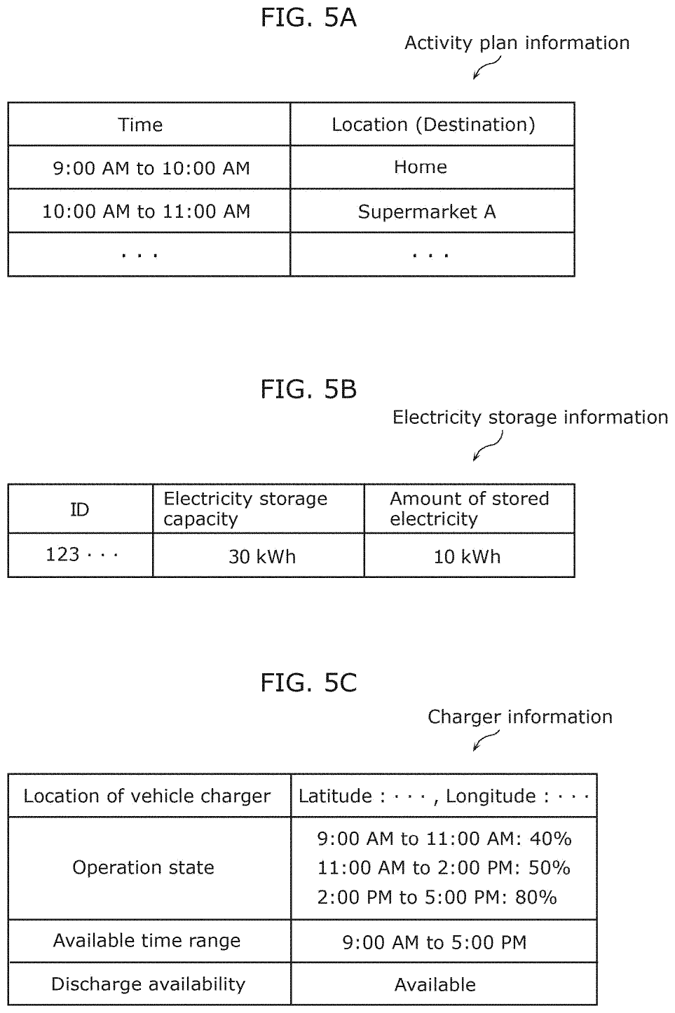

Vehicle 110 is connected to and can communicate with server device 120. Vehicle 110 outputs electricity storage information (see FIG. 5B described later) to server device 120. The electricity storage information includes the electricity storage capacity of the battery of vehicle 110 and the amount of electricity stored currently in the battery.

Server device 120 executes a process for balancing the supply and demand of electric power while maintaining user-friendliness for user U. Server device 120 determines a charging timing and a charging location for balancing the supply and demand of electric power while maintaining user-friendliness for user U, based on activity plan information including an activity plan of user U of vehicle 110 and electricity storage information of the storage battery of vehicle 110. The charging timing indicates a timing for charging the storage battery of vehicle 110, and the charging location indicates the location of vehicle charger 141 for charging the storage battery. Server device 120 then notifies user U of information indicating the determined charging timing and charging location via information terminal 130. Server device 120 includes communicator 121, controller 122, and storage 123. In the following description, “a charging timing of a storage battery of vehicle 110” may also be referred to as “a charging timing of vehicle 110”.

Communicator 121 is a communication circuit (a communication module) for server device 120 to communicate with, for example but not limited to, vehicle 110, information terminal 130, or charging station 140. Communicator 121 transmits and receives various items of information under the control of controller 122.

Controller 122 is a control device that controls each constituent element of server device 120. Controller 122 obtains activity plan information of user U, electricity storage information of vehicle 110, and charger and discharger information of vehicle charger 141 at charging station 140 and stores the obtained items of information into storage 123. Controller 122 may obtain the activity plan information from information terminal 130 or obtain the activity plan information from another server device managing schedules. The activity plan information may be obtained by use of, for example, a dedicated application. Controller 122 may obtain, for example, the activity plan information that is based on an activity plan of user U who has input the activity plan into information terminal 130 via a dedicated application installed in information terminal 130. Alternatively, controller 122 may obtain the activity plan information by predicting an activity plan of user U.

In this example, controller 122 may obtain the activity plan information, for example, before user U carries out an activity in the activity plan. Controller 122 may obtain the activity plan information for the next day and beyond, for example, on the present day. This configuration allows server device 120 to determine the charging timing and the charging location for the next day and beyond on the present day and to notify user U accordingly.

Meanwhile, controller 122 may obtain the electricity storage information of the battery of vehicle 110 from vehicle 110 or obtain the electricity storage information from another server device managing electricity storage information. Meanwhile, controller 122 may obtain the charger information including the location of vehicle charger 141 that can charge the storage battery of vehicle 110 from charging station 140 provided with this vehicle charger 141 or obtain the charger information from another server device managing charger information.

Controller 122 outputs recommendation information generated by generator 122c to information terminal 130 via communicator 121.

Now, activity plan information, electricity storage information, and charger information will be described with reference to FIG. 5A to FIG. 5C. FIG. 5A is a table illustrating an example of activity plan information according to the present embodiment.

As illustrated in FIG. 5A, the activity plan information is information that indicates a schedule of user U and includes information pertaining to Time and Location.

Time is information indicating a time range corresponding to Location and is expressed in the form of, for example, 9:00 AM to 10:00 AM. Location is information indicating a location or a destination where user U will be during the corresponding time range and is, for example, home or supermarket A. In the example illustrated in FIG. 5A, the activity plan information indicates that user U will be home between 9:00 AM and 10:00 AM and will go to supermarket A for grocery shopping between 10:00 AM and 11:00 AM.

In this example, the activity plan information may further include information indicating, for example but not limited to, a traveling route that user U takes when going out by vehicle 110, the duration of stay at a destination, or the number of occupants in vehicle 110.

The information indicating Location may be inferred by controller 122. Controller 122 may infer Location of user U based, for example, on the past activity history of user U or a plan of user U. In a case where user U is scheduled to have a meeting between 10:00 AM and 11:00 AM, for example, controller 122 may infer that user U will be at his or her workplace during that time period.

FIG. 5B is a table illustrating an example of electricity storage information according to the present embodiment.

As illustrated in FIG. 5B, the electricity storage information includes information pertaining to ID, Electricity storage capacity, and Amount of stored electricity.

ID is identification information for identifying vehicle 110. Electricity storage capacity indicates the electricity storage capacity (the maximum capacity) of the battery of vehicle 110. The maximum capacity changes over time due to deterioration or the like. Electricity storage capacity may be a full charge capacity at a given time point. Amount of stored electricity indicates the amount of electricity stored currently in the battery of vehicle 110. In the example illustrated in FIG. 5B, the electricity storage information indicates that the electricity storage capacity is 30 kWh and that the amount of stored electricity is 10 kWh. In other words, vehicle 110 currently has a remaining capacity of 20 kWh and can be charged with 20 kWh.

In this example, the electricity storage information may further include information indicating, for example but not limited to, the amount of electricity to be stored after vehicle 100 has been charged with the amount desired by user U. With this configuration, generator 122c, described later, can determine the charging timing and the charging location to be recommended in at least one of a case where the battery is to be charged to its electricity storage capacity or a case where the battery is to be charged to the amount of stored electricity that user U desires.

For example, controller 122 obtains the electricity storage information periodically from vehicle 110.

FIG. 5C is a table illustrating an example of charger information according to the present embodiment.

As illustrated in FIG. 5C, the charger information includes information pertaining to Location of vehicle charger, Operation state, Available time range, and Discharge availability.

Location of vehicle charger is information indicating the location where vehicle charger 141 is installed. Location of vehicle charger indicates, for example, the latitude and the longitude of charging station 140 where vehicle charger 141 is installed or may indicate the address of such charging station 140. Operation state is information indicating the operation state of vehicle charger 141 and is, for example, the rate of operation. For example, the rate of operation of vehicle charger 141 between 9:00 AM and 11:00 AM is 40%. Operation state is included, for example, in charger information of vehicle charger 141 installed in a public space. Herein, the information indicating Operation state is an example of operation information.

Available time range indicates the time range in which vehicle charger 141 is available for use and is, for example, from 9:00 AM to 5:00 PM. Available time range may be the time range in which charging station 140 where corresponding vehicle charger 141 is installed is open. Discharge availability is information indicating whether corresponding vehicle charger 141 supports discharging and states, for example, that discharging is available or not available.

In this example, the charger information may further include information indicating whether vehicle charger 141 is in service. For example, as the information indicating whether vehicle charger 141 is in service, the charger information may include information indicating, for example, that vehicle charger 141 is out of service from 9:00 AM to 1:00 PM for inspection. Available time range and the information indicating whether vehicle charger 141 is in service are each an example of availability information.

Controller 122 obtains charger information for each of a plurality of vehicle chargers 141 included in a predetermined region. The predetermined region is set in advance and may be, for example, a region, on a map, including each consumer in a community that a resource aggregator manages, a region, on a map, including all the consumers in each community that an aggregation coordinator manages, or an administrative section such as a municipality.

Referring back to FIG. 4, controller 122 includes predictor 122a, determiner 122b, and generator 122c.

Predictor 122a predicts a change over time in electric power demand. Predictor 122a predicts, for example, diurnal variations in electric power demand. Predictor 122a predicts, for example, actual electric power demand such as those illustrated in FIG. 3. Predictor 122a predicts, for example, current and later actual electric power demand based on data indicating past actual electric power demand. There is no particular limitation on how predictor 122a predicts actual electric power demand. For example, predictor 122a predicts actual electric power demand to be observed in a given time range or on a given date and time based on actual electric power demand data from a past time range or on a past date and time with at least one of the location, the temperature, the season, or the weather in the data matching or being similar to the counterpart in the given time range or on the given date and time. Herein, being similar means that the difference between the at least one of the location, the temperature, the season, or the weather in the time range or on the date and time for which actual electric power demand is to be predicted and the corresponding at least one of the location, the temperature, the season, or the weather observed when the past actual electric power demand data was obtained satisfies a predetermined condition. Description will be elaborated with a case where the at least one of the location, the temperature, the season, or the weather is the location serving as an example. In this case, the predetermined condition may be that the difference between the locations is within a few kilometers, that the community in question is adjacent to the community that user U belongs to on a map, or that the energy management system in question is adjacent to energy management system 1 that user U belongs to on a map.

Determiner 122b determines a charging timing and a charging location of vehicle 110 to be recommended to user U so as to reduce the peak demand along a change over time in electric power demand predicted by predictor 122a, based on activity plan information, electricity storage information, and charger information. This can be rephrased as that determiner 122b determines, based on the activity plan information, the electricity storage information, and the charger information, vehicle charger 141 for charging the storage battery of vehicle 110 from among a plurality of vehicle chargers 141 included in a predetermined region.

Generator 122c generates recommendation information including the charging timing and the charging location of vehicle 110 determined by determiner 122b. The charging timing is, for example, a time range recommended for charging. The charging location indicates the location where vehicle charger 141 for charging the storage battery of vehicle 110 is installed.

As shown in display 131 in FIG. 4, for example, generator 122c generates recommendation information for showing the charging timing (e.g., between 10:00 AM and 11:00 AM tomorrow) and the charging location where vehicle charger 141 to be used to charge vehicle 110 at the charging timing is installed. In FIG. 4, the charging location is marked by a solid star symbol on the map. In this example, the current location of user U may be shown on the map. In FIG. 4, the current location of user U is marked by a solid circle on the map. Furthermore, the traveling route from the current location of user U to the charging location may be shown on the map. The charging location may be shown by characters indicating, for example, its address.

Storage 123 is a storage device that stores various items of information for processing of controller 122. Storage 123 may store, for example but not limited to, activity plan information, electricity storage information, or charger information. Storage 123 may further store, for example but not limited to, traveling history of vehicle 110 or past actual electric power demand data to be used for predictor 122a to make predictions. Storage 123 is implemented, for example, by a semiconductor memory.

In this example, server device 120 may be, for example, a server device that a resource aggregator or an aggregation coordinator manages or a server device external to energy management system 1 illustrated in FIG. 1.

Information terminal 130 is a terminal device owned by user U. Information terminal 130 is capable of communicating with server device 120. There is no particular limitation on information terminal 130 as long as information terminal 130 can present recommendation information, and information terminal 130 may be, for example, a smartphone, a tablet terminal, or a personal computer. Information terminal 130 may also be, for example, a voice input and output device without a display.

Information terminal 130 includes display 131 and presents recommendation information to user U by providing display corresponding to the recommendation information on display 131. In this example, information terminal 130 may present recommendation information to user U, for example, audibly. Display 131 is implemented by a liquid crystal panel or may be implemented by a different kind of display panel, such as an organic EL panel. Display 131 may include backlight.

Information terminal 130 further includes a receiver (not illustrated) for receiving an input from user U and may receive, via the receiver, an input pertaining to an activity plan of user U. Information terminal 130 transmits information indicating the received input to server device 120. Information terminal 130 transmits to server device 120, for example, activity plan information indicating the activity plan received via an inputter. The receiver is, for example but not limited to, a touch panel, a keyboard, or a push button. Alternatively, the receiver may be, for example, a microphone that receives voice input.

Charging station 140 is a facility for charging vehicle 110. Charging station 140 includes one or more vehicle chargers 141. Vehicle charger 141 is an electric power feeding device for supplying electric power to vehicle 110 from an electric power grid. In a case where vehicle charger 141 is equipped with a discharging function, vehicle charger 141 supplies the electric power from vehicle 110 to an electric power consuming load (e.g., an electrical apparatus installed in the facility) connected to this vehicle charger 141. In this manner, vehicle charger 141 may be a charger capable of only charging or a charger-discharger capable of both charging and discharging. In other words, charging station 140 may be a charging and discharging station.

Herein, there is no particular limitation on the number of charging stations 140 included in recommended action output system 100. For example, all charging stations 140 provided in a predetermined region may be included in recommended action output system 100. Moreover, there is no particular limitation on the number of vehicle chargers 141 installed at charging station 140, and only one vehicle charger 141 or two or more vehicle chargers 141 may be installed at charging station 140. Vehicle charger 141 is installed, for example but not limited to, at a residential building, at an apartment complex, or in a public space.

### [2. Operation of Recommended Action Output System]

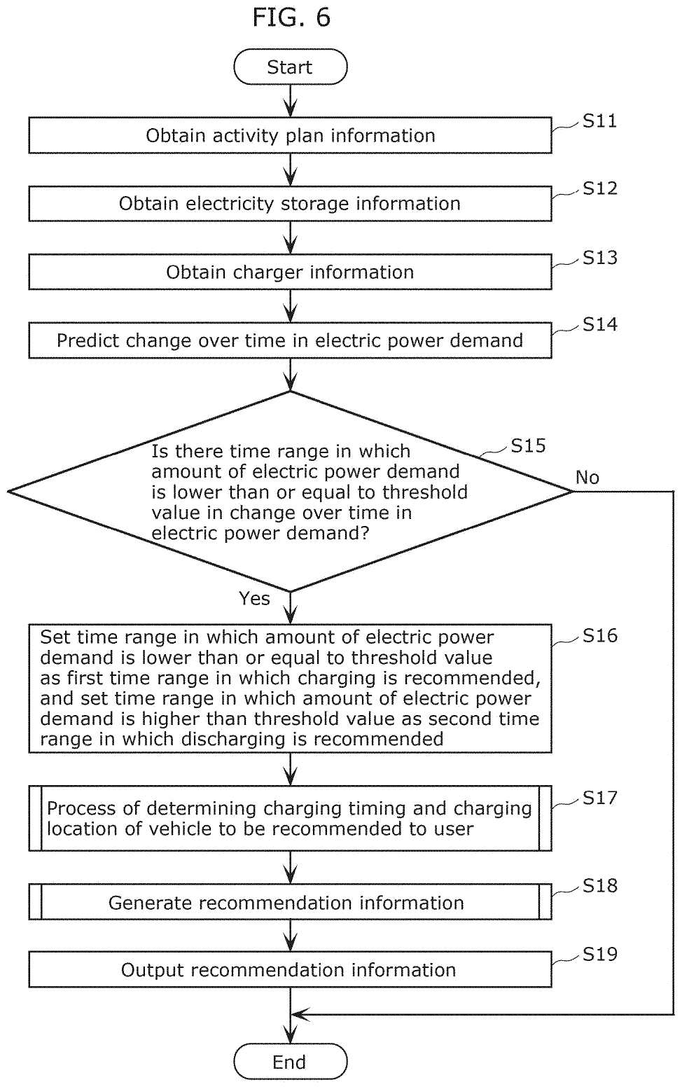

Next, an operation of recommended action output system 100 described above will be described with reference to FIG. 6 to FIG. 11. FIG. 6 is a flowchart illustrating an operation of recommended action output system 100 according to the present embodiment.

As illustrated in FIG. 6, controller 122 of server device 120 obtains activity plan information (S11). Controller 122 obtains, for example, activity plan information such as the one illustrated in FIG. 5A from information terminal 130 via communicator 121. In this manner, communicator 121 functions as a first obtainer that obtains activity plan information.

Next, controller 122 obtains electricity storage information (S12). Controller 122 obtains, for example, electricity storage information such as the one illustrated in FIG. 5B from vehicle 110 via communicator 121. In this manner, communicator 121 functions also as a second obtainer that obtains electricity storage information. Controller 122 obtains electricity storage information, for example, periodically.

Next, controller 122 obtains charger information (S13). Controller 122, for example, reads out charger information such as the one illustrated in FIG. 5C from storage 123. In this manner, controller 122 functions as a third obtainer that obtains charger information.

In this example, controller 122 may execute steps S12 and S13, for example, in response to obtaining the activity plan information at step S11.

Next, predictor 122a predicts a change over time in electric power demand (S14). Predictor 122a predicts, for example, a change over time in actual electric power demand such as those illustrated in FIG. 3 to be observed in the time range or on the date and time for which the prediction is to be made (e.g., tomorrow, this date and time may also referred to as a target date and time hereinafter), based on the amount of electric power demand of each consumer and the amount of generated electricity at each consumer. Predictor 122a, for example, predicts the change over time in actual electric power demand to be observed on the target date and time by averaging or taking a weighted average of items of past data where at least one of the location, the temperature, the season, or the weather matches or is similar to the corresponding at least one of the location, the temperature, the season, or the weather on the target date and time. The target date and time is a date and time in the future that comes after the time point when the prediction is made. Predictor 122a may, for example, set, as the target date and time, the date and time on which user U is scheduled to travel with vehicle 110 according to the activity plan information. In the following description, the assumption is that predictor 122a has predicted the change over time in actual electric power demand in year 2020 indicated in FIG. 3.

Next, predictor 122a determines whether there is a time range in which the amount of electric power demand (electric power demand amount) indicated by the electric power demand is lower than or equal to a threshold value in the change over time in the electric power demand (S15). There is no particular limitation on the threshold value as long as the electric power grid can supply electric power stably at the electric power amount indicated by the threshold value. In FIG. 3, a threshold value of 17,000 MW is indicated as an example, but this threshold value is not a limiting example.

Next, if there is a time range in which the amount of electric power demand is lower than or equal to the threshold value (Yes at S15), predictor 122a sets this time range as a first time range in which charging is recommended and sets a time range in which the amount of electric power demand exceeds the threshold value as a second time range in which discharging is recommended (S16). To elaborate on this with the example illustrated in FIG. 3, predictor 122a sets the time range from around 9:00 to 18:00, in which the amount of electric power demand is lower than or equal to the threshold value, as the first time range and sets the remaining time range as the second time range. In other words, predictor 122a sets a time range in which actual electric power demand is low as the first time range and sets a time range in which actual electric power demand is high as the second time range. The second time range includes a time range (the time range around 20:00 in the example illustrated in FIG. 3) in which the actual electric power demand reaches its peak demand in the diurnal variations. Herein, at step S16, predictor 122a may set the first period on at least the target date and time.

Next, predictor 122a and determiner 122b perform a process of determining a charging timing and a charging location of vehicle 110 to be recommended to user U based on the activity plan information, the electricity storage information, and the charger information (S17). Step S17 will be described later in detail.

Determiner 122b determines the charging timing and the charging location so as to reduce the peak demand in at least the predicted actual electric power demand. Determiner 122b may determine one charging timing and one charging location or a plurality of charging timings and a plurality of charging locations. In the example illustrated in FIG. 4, the charging timing and the charging location determined by determiner 122b are shown as recommendation information.

Next, generator 122c generates recommendation information for recommending user U the determined charging timing and charging location of vehicle 110 (S18). In a case where vehicle charger 141 provided at the home of user U supports discharging, for example, generator 122c may generate, at step S18, recommendation information further including information for recommending user U a discharging timing of vehicle 110. This recommendation information includes information recommending that the storage battery of vehicle 110 be discharged in the second time range. The recommendation information may include information recommending that vehicle 110 be discharged in a time range that includes the time at which the electric power demand reaches its peak demand in the second time range. Generator 122c may generate, at step S18, recommendation information including information recommending that vehicle 110 be not charged in the second time range, for example.

Next, controller 122 outputs the recommendation information generated by generator 122c to information terminal 130 via communicator 121 (S19). With this operation, user U can find the recommended charging timing and charging location of vehicle 110 by checking the recommendation information presented on information terminal 130. In this manner, communicator 121 functions as an outputter that outputs recommendation information.

Meanwhile, if there is no time range in which the amount of electric power demand is lower than or equal to the threshold value (No at S15), predictor 122a terminates the process. In this case, controller 122 may generate recommendation information recommending that vehicle 110 be not charged or be charged on a different day.

The operation illustrated in FIG. 6 may be performed, for example, before user U rides vehicle 110. If server device 120 obtains activity plan information, electricity storage information, and charger information before user U rides vehicle 110, for example, server device 120 can output recommendation information to information terminal 130 of user U in advance.

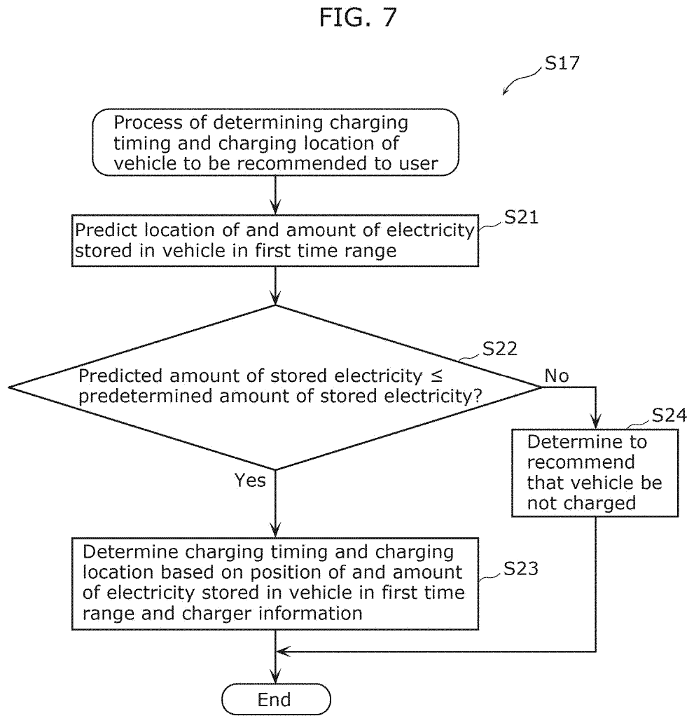

Now, the process of determining the charging timing and the charging location of vehicle 110 to be recommended to user U will be described with reference to FIG. 7 to FIG. 10. FIG. 7 is a flowchart illustrating a first example of the process of determining the charging timing and the charging location (S17) indicated in FIG. 6.

As illustrated in FIG. 7, predictor 122a predicts the location of and the amount of electricity stored in vehicle 110 in the first time range based on the activity plan information (S21). In the example illustrated in FIG. 5A, predictor 122a predicts that vehicle 110 will be located at the home of user U since user U will be home between 9:00 AM and 10:00 AM. In addition, since vehicle 110 is not moving during this time period, the amount of electricity stored in the battery will not decrease. For example, the amount of electricity stored in vehicle 110 between 9:00 AM and 10:00 AM remains the same as the amount of stored electricity included in the electricity storage information obtained at step S12.

In the example illustrated in FIG. 5A, predictor 122a predicts that vehicle 110 will be located at supermarket A since user U will be at supermarket A between 10:00 AM and 11:00 AM. How the location of vehicle 110 is predicted is not limited to the method described above. Since vehicle 110 will travel in this case, the amount of electricity stored in the battery will decrease. The amount of decrease in the amount of stored electricity is calculated based, for example, on the distance between the home and supermarket A (e.g., the traveling distance), but this is not a limiting example. Predictor 122a predicts the amount of electricity stored in vehicle 110 in the first time range based on the amount of electricity stored in vehicle 110 included in the electricity storage information and the aforementioned amount of decrease in the amount of stored electricity.

Next, determiner 122b determines whether the predicted amount of stored electricity is lower than or equal to a predetermined amount of stored electricity (S22). The predetermined amount of stored electricity may be an amount of stored electricity based on which whether vehicle 110 needs to be charged is determined and may be determined, for example, based on the charging capacity of the battery of vehicle 110. The predetermined amount of stored electricity may be obtained, for example, from information terminal 130. In other words, the predetermined amount of stored electricity may be set by user U.

At step S22, determiner 122b may determine whether vehicle 110 should be charged in the first time range based on the difference between the electricity storage capacity of the battery included in the electricity storage information and the amount of stored electricity in the first time range predicted by predictor 122a.

Next, if the predicted amount of stored electricity is lower than or equal to the predetermined amount of stored electricity (Yes at S22), determiner 122b determines the charging timing and the charging location based on the location of and the amount of electricity stored in vehicle 110 in the first time range and the charger information (S23). Determiner 122b determines the charging location based on the location of vehicle 110 in the first time range and the location of vehicle charger 141. Determiner 122b, for example, identifies vehicle charger 141 located close to the location of vehicle 110 based on the location of vehicle 110 in the first period (e.g., a destination) and the location of vehicle charger 141 included in the charger information, and determines the installation location where identified vehicle charger 141 is installed as the charging location. Determiner 122b determines the time range from 10:00 AM to 11:00 AM in which user U goes to supermarket A (e.g., the time range in which user U uses vehicle 110) as the charging timing. The charging timing is a timing in the first time range.

Determiner 122b may, for example, determine, as the charging timing of vehicle 110, a timing at which the amount of stored electricity is neither lower than nor equal to a first amount of stored electricity. The first amount of stored electricity is an amount of stored electricity where the amount of electricity stored in the battery has decreased and the battery needs to be charged immediately and is determined as appropriate in accordance with, for example, the distance that vehicle 110 can travel.

In this manner, determiner 122b determines the charging timing and the charging location based on the schedule of user U in the first time range in which charging is recommended. With this configuration, user U can charge vehicle 110 by stopping by the charging location on his or her way to some place else without going out to the charging location just to charge vehicle 110, and thus user-friendliness for user U is not likely to decrease.

As described above, server device 120 determines the charging timing and charging location in accordance with the location of vehicle 110 (i.e., the location of user U) in the first time range. Since the charging in the first time range is determined and user U is notified accordingly, the likelihood that vehicle 110 is charged during peak demand can be expected to decrease. In other words, the peak demand can be reduced.

In a case where a plurality of vehicles that need to be charged are located in a predetermined region, for example, server device 120 may determine the charging location of each of a plurality of vehicle chargers 141 so as to reduce (e.g., to reduce to the minimum) the traveling distance of each of the plurality of vehicles to respective vehicle chargers 141, in accordance with the locations of the plurality of vehicles that need to be charged and the locations of the plurality of vehicle chargers 141 installed in the predetermined region.

Meanwhile, if the predicted amount of stored electricity is higher than the predetermined amount of stored electricity (No at S22), determiner 122b determines to recommend that vehicle 110 be not charged (S24). In this case, the recommendation information generated at step S18 includes information recommending that vehicle 110 be not charged in the first time range.

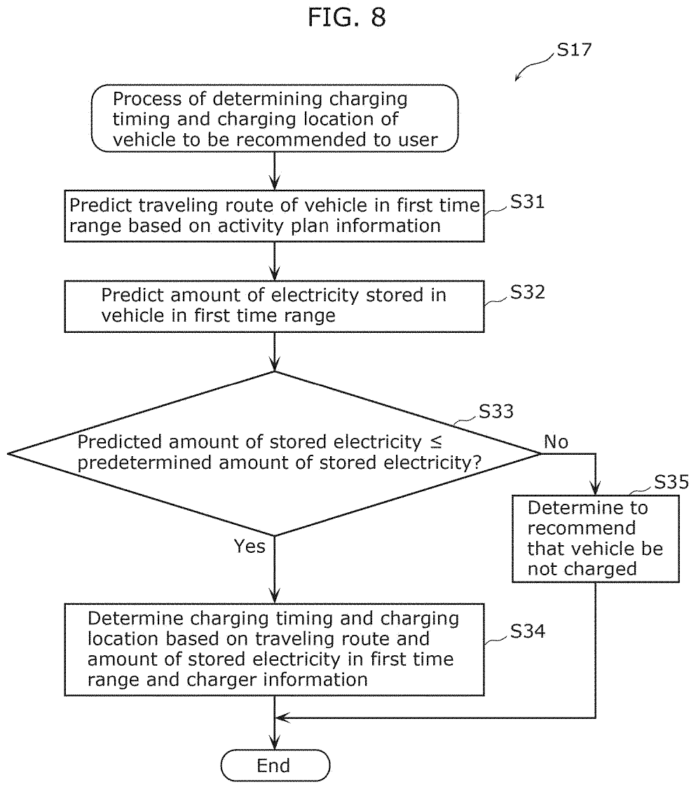

Next, a process of determining the charging timing and the charging location of vehicle 110 to be recommended to user U in a case where predictor 122a predicts a traveling route of vehicle 110 will be described with reference to FIG. 8. FIG. 8 is a flowchart illustrating a second example of the process of determining the charging timing and the charging location (S17) indicated in FIG. 6.

As illustrated in FIG. 8, predictor 122a predicts a traveling route of vehicle 110 in the first time range based on the activity plan information (S31). Predictor 122a, for example, predicts the traveling route to a destination based on the destination included in the activity plan information and history of past traveling routes of vehicle 110 (traveling history). In the example illustrated in FIG. 5A, since user U travels from home to supermarket A, predictor 122a predicts a traveling route from home to supermarket A based on the past traveling history from home to supermarket A. In this manner, predictor 122a predicts where vehicle 110 will be or will be traveling in the first time range in which vehicle 110 is recommended to be charged, based on the activity plan information.

Predictor 122a may, for example, set the traveling route indicated by the most recent item of traveling history among items of traveling history as the traveling route in the first time range on the target date and time or set the traveling route with the highest number of occurrences in items of traveling history as the traveling route in the first time range on the target date and time.

Next, predictor 122a predicts the amount of electricity stored in vehicle 110 in the first time range (S32). Predictor 122a predicts the amount of electricity stored in vehicle 110 based on the traveling route predicted at step S31. This configuration allows predictor 122a to predict the amount of electricity stored in vehicle 110 in accordance with the traveling route, and thus the accuracy of predicting the amount of stored electricity improves.

There is no particular limitation on the method with which predictor 122a predicts the amount of stored electricity. For example, predictor 122a may predict the amount of electricity stored in vehicle 110 in the first time range based on a change in the amount of electricity stored in the battery observed when vehicle 110 has traveled in the past the traveling route predicted at step S31 (i.e., the amount of electric power used) or may predict the amount of electricity stored in vehicle 110 in the first time range based on information indicating a relationship between the traveling distance along the traveling route predicted at step S31 and a change in the amount of stored electricity (i.e., the amount of electric power used).

Next, determiner 122b determines whether the predicted amount of stored electricity is lower than or equal to a predetermined amount of stored electricity (S33). Step S33 is similar to step S22 of FIG. 7, and thus description thereof will be omitted.

Next, if the predicted amount of stored electricity is lower than or equal to the predetermined amount of stored electricity (Yes at S33), determiner 122b determines the charging timing and the charging location based on the traveling route of and the amount of electricity stored in vehicle 110 in the first time range and the charger information (S34). Determiner 122b determines the charging location based on the traveling route of vehicle 110 in the first time range and the location of vehicle charger 141. Determiner 122b, for example, identifies vehicle charger 141 located close to the traveling route of vehicle 110 based on the traveling route of vehicle 110 in the first time range and the charger information, and determines the installation location where identified vehicle charger 141 is installed as the charging location. Determiner 122b determines a timing when vehicle 110 travels on or in the vicinity of the determined charging location as the charging timing. This configuration allows determiner 122b to determine the charging timing more finely.

Meanwhile, if the predicted amount of stored electricity is higher than the predetermined amount of stored electricity (No at S33), determiner 122b determines to recommend that vehicle 110 be not charged (S35). In this case, the recommendation information generated at step S18 includes information recommending that vehicle 110 be not charged in the first time range.

In this manner, determiner 122b predicts a traveling route based on the schedule of user U in the first time range in which charging is recommended and determines the charging timing and the charging location based on the predicted traveling route. This configuration allows determiner 122b to determine the charging timing and the charging location that are more appropriate for user U.

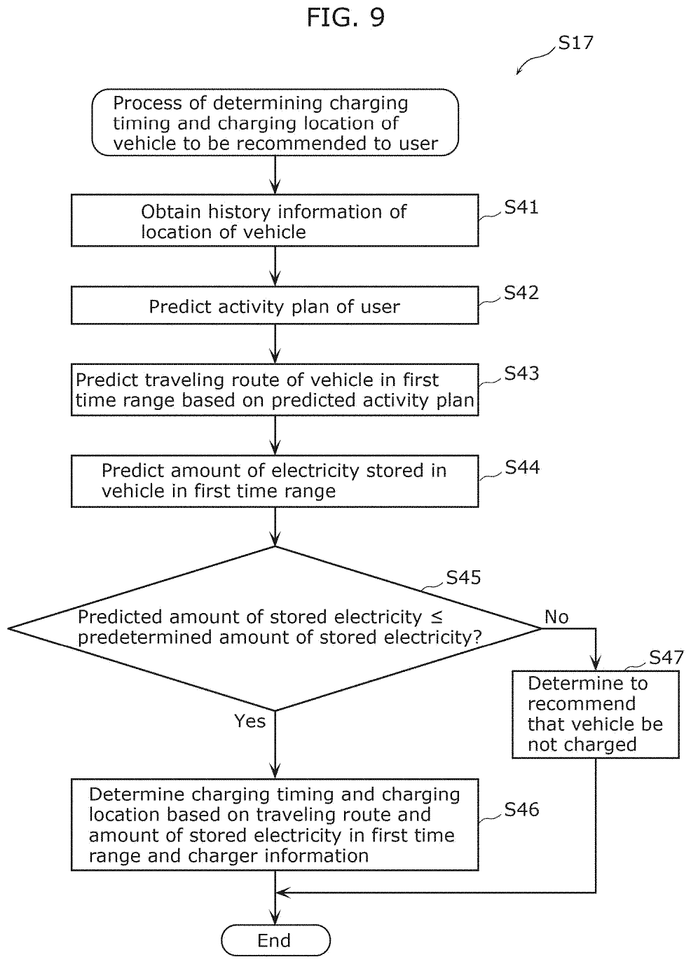

Next, a process of determining the charging timing and the charging location of vehicle 110 to be recommended to user U in a case where predictor 122a predicts an activity plan of user U will be described with reference to FIG. 9. FIG. 9 is a flowchart illustrating a third example of the process of determining the charging timing and the charging location (S17) indicated in FIG. 6. In this example, step S11 of FIG. 6 does not need to be executed. In other words, server device 120 does not need to obtain the activity plan information of user U from an external device.

As illustrated in FIG. 9, predictor 122a obtains history information of the location of vehicle 110 (S41). The history information of the location of vehicle 110 may be information that is based on the past schedule of user U or information that is based on the traveling history of vehicle 110. The history information of the location of vehicle 110 is stored in storage 123, and predictor 122a obtains the history information by reading out the history information from storage 123. At step S41, predictor 122a obtains, for example, the traveling history of vehicle 110 in the past first time range as the history information.

Next, predictor 122a predicts an activity plan of user U based on the history information of the location of vehicle 110 (S42). Predictor 122a, for example, obtains the regularity of the activity of user U from the history information of the location of vehicle 110 and predicts the activity plan of user U based on the obtained regularity. The regularity means that a correspondence between a date and time and a location is repeated periodically and, for example, means that user U is at a specific location every week, on a specific day of the week, or in a specific time range. If predictor 122a obtains regularity indicating that user U goes to supermarket A between 10:00 AM and 11:00 AM every week on a specific day of the week, for example, predictor 122a predicts that user U will go to supermarket A between 10:00 AM and 11:00 AM next week on that specific day of the week. This can be rephrased as that predictor 122a predicts a habitual activity of user U based on the history information of the location of vehicle 110. Information indicating an activity plan predicted by predictor 122a is an example of activity plan information. In other words, activity plan information may be generated by server device 120.

Next, predictor 122a predicts a traveling route of vehicle 110 in the first time range based on the predicted activity plan (S43). Steps S43 to S47 are similar to, respectively, step S31 to S35 of FIG. 8, and thus description thereof will be omitted.

In this manner, server device 120 predicts an activity plan of user U based on history information of the location of vehicle 110 without obtaining activity plan information of user U from an external device. This configuration can reduce the communication traffic between server device 120 and an external device. In addition, the above configuration makes it possible to determine the charging timing and the charging location even when the condition of communication between server device 120 and an external device is not good.

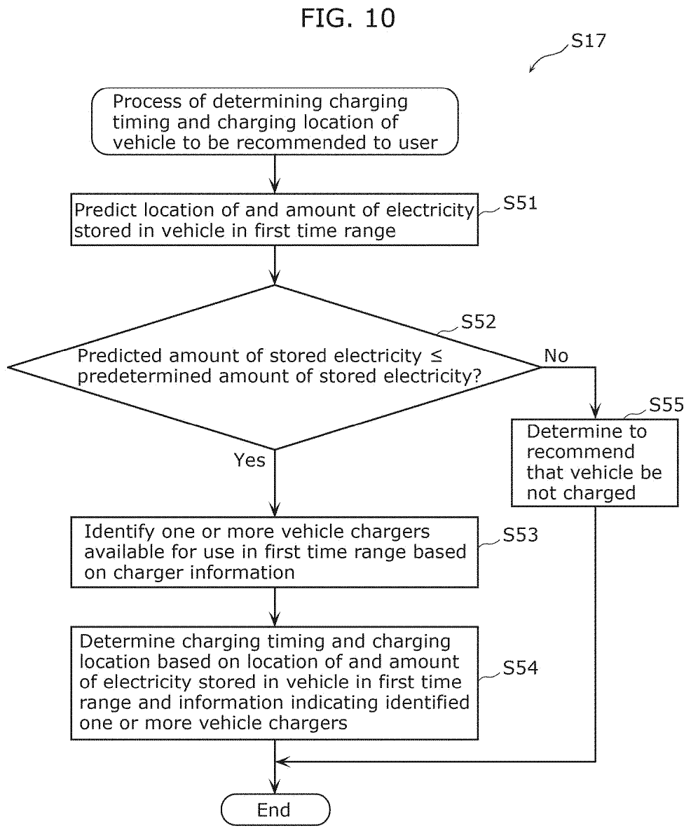

Next, a process of determining the charging timing and the charging location of vehicle 110 to be recommended to user U in a case where charger information includes information indicating an available time range will be described with reference to FIG. 10. FIG. 10 is a flowchart illustrating a fourth example of the process of determining the charging timing and the charging location (S17) indicated in FIG. 6.

As illustrated in FIG. 10, predictor 122a predicts the location of and the amount of electricity stored in vehicle 110 in the first time range based on the activity plan information (S51). Then, predictor 122a determines whether the predicted amount of stored electricity is lower than or equal to a predetermined amount of stored electricity (S52). Steps S51 and S52 are similar to, respectively, steps S21 and S22 of FIG. 7, and thus description thereof will be omitted.

Next, if the predicted amount of stored electricity is lower than or equal to the predetermined amount of stored electricity (Yest at S52), predictor 122a identifies, from among a plurality of vehicle chargers 141 in a predetermined region, one or more vehicle chargers 141 that are available for use in the first time range, based on the charger information (S53). Predictor 122a identifies one or more vehicle chargers 141 that are available for use in the first time range based, for example, on information indicating the available time range included in the charger information. Predictor 122a may identify one or more vehicle chargers 141 based on whether the time range (e.g., between 9:00 AM and 5:00 PM in the example illustrated in FIG. 5C) indicated by the available time range is included in the first time range.

Predictor 122a may identify one or more vehicle chargers 141 based on whether the time range indicated by the available time range includes the time range (e.g., between 10:00 AM and 11:00 AM in the example illustrated in FIG. 5A) in which user U may drive vehicle 110 according to the activity plan information. In other words, if user U can charge vehicle 110 with vehicle charger 141 in the time range indicated by the available time range, as determined based on the activity plan information, predictor 122a may identify this vehicle charger 141 as one or more vehicle chargers 141 that are available for use in the first time range.

Next, determiner 122b determines the charging timing and the charging location based on information indicating the location of and the amount of electricity stored in vehicle 110 in the first time range and identified one or more vehicle chargers 141 (S54). This configuration allows determiner 122b to determine vehicle charger 141 for charging vehicle 110 from one or more vehicle chargers 141 that are available for use in the first time range among the plurality of vehicle chargers 141 installed in the predetermined region, and thus the reliability of being able to charge vehicle 110 increases.

Meanwhile, if the predicted amount of stored electricity is higher than the predetermined amount of stored electricity (No at S52), predictor 122a determines to recommend that vehicle 110 be not charged (S55).

Herein, predictor 122a performs the process at step S53 based on the information indicating the available time range included in the charger information, but this is not a limiting example. Predictor 122a may perform the process at step S53 based, for example, on information indicating the operation state included in the charger information. Predictor 122a may, for example, identify vehicle charger 141 whose rate of operation in the first time range is lower than or equal to a predetermined value as one or more vehicle chargers 141 available for use. This configuration allows user U to charge vehicle 110 smoothly, and thus predictor 122a can reduce an influence that the charging operation of vehicle 110 has on the schedule of user U. In other words, predictor 122a can further suppress a decrease in user-friendliness for user U.

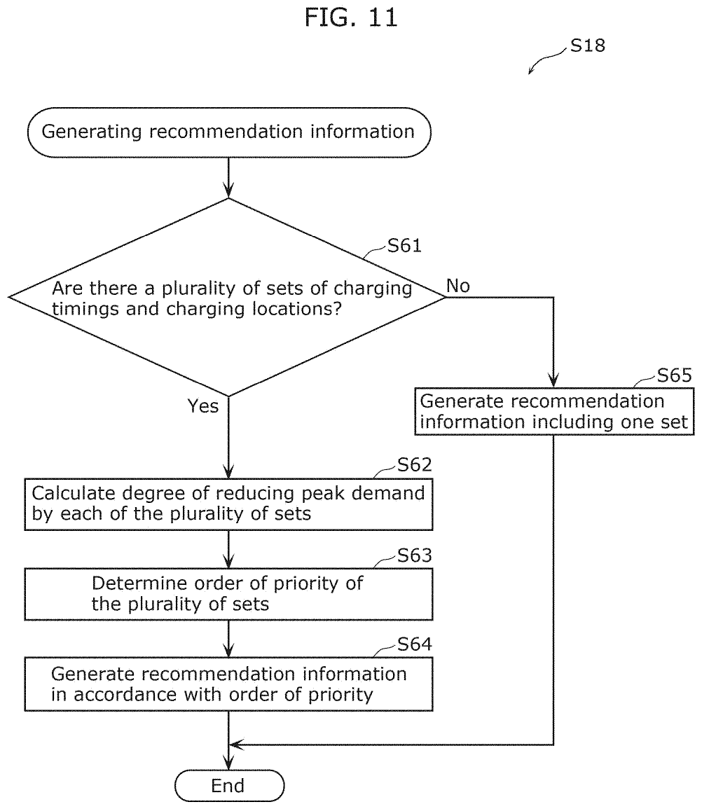

Now, a process of generating recommendation information to be recommended to user U will be described with reference to FIG. 11. FIG. 11 is a flowchart illustrating an example of the process of generating recommendation information (S18) indicated in FIG. 6. Specifically, a process performed in a case where there are a plurality of sets of charging timings and charging locations will be described with reference to FIG. 11.

As illustrated in FIG. 11, generator 122c determines whether there are a plurality of sets of charging timings and charging locations determined by determiner 122b (S61). If there are a plurality of sets of charging timings and charging locations determined by determiner 122b (Yes at S61), generator 122c calculates the degree to which each of the plurality of sets reduces the peak demand (S62). Generator 122c, for example, sets the degree to which the peak demand is reduced higher as the charging timing is closer to the time range in which the demand reaches its peak. How the degree to which the peak demand is reduced is calculated is not limited to this example.

Next, generator 122c determines the order of priority of the plurality of sets based on the degree to which each of the plurality of sets reduces the peak demand (S63) and generates recommendation information in accordance with the determined order of priority (S64). Generator 122c sets the order of priority higher as the degree to which the peak demand is reduced is higher. Generator 122c may, for example, vary the way how the charging timing and the charging location are displayed in accordance with the order of priority. Generator 122c, for example, displays the charging timing and the charging location larger as their order of priority is higher.

Meanwhile, if there is only one set of a charging timing and a charging location determined by determiner 122b (No at S61), generator 122c generates recommendation information including the one set of a charging timing and a charging location (S65).

In this manner, in a case where there are a plurality of sets of charging timings and charging locations determined by determiner 122b, server device 120 determines the order of priority of the charging timings and the charging locations to be recommended to user U from the standpoint of the degree to which the peak demand is reduced. This configuration allows server device 120 to reduce the peak demand effectively.

Generator 122c is not limited to determining the order of priority based on the degree to which the peak demand is reduced. Generator 122c may, for example, determine the order of priority based on the preference of user U or determine the order of priority based on the rate of operation. In a case where user U tends to prefer charging vehicle 100 with vehicle charger 141 closer to user U, for example, generator 122c may determine the order of priority such that the order of priority is higher as the distance between the installation location of vehicle charger 141 and the traveling route is shorter. Alternatively, generator 122c may determine the order of priority, for example, such that vehicle charger 141 with a lower rate of operation has a higher order of priority.

### [3. Advantageous Effects and Others]

As described thus far, recommended action output system 100 includes communicator 121, controller 122, predictor 122a, determiner 122b, and communicator 121. Communicator 121 obtains activity plan information and electricity storage information. The activity plan information includes an activity plan of user U of vehicle 110 provided with a storage battery. The electricity storage information includes the electricity storage capacity of the storage battery of vehicle 110 and the amount of electricity stored currently in the storage battery. Controller 122 obtains charger information that includes the location of vehicle charger 141 installed in a specific area. Predictor 122a predicts a change over time in electric power demand in the specific area. Determiner 122b determines a charging timing of the storage battery of vehicle 110 to be recommended to user U and a charging location indicating the location of vehicle charger 141 for charging the storage battery so as to reduce the peak demand in the predicted change over time in the electric power demand, based on the activity plan information, the electricity storage information, and the charger information. Communicator 121 outputs recommendation information that includes the determined charging timing and charging location.

Herein, communicator 121 functions as a first obtainer, a second obtainer, and an outputter. Controller 122 is an example of a third obtainer, and user U is an example of a user.

With this configuration, the charging timing and the charging location of vehicle 110 are determined based on the activity plan of user U, and thus user U merely needs to go to the charging location on his or her way to some place else without having to go out to the charging location only to charge vehicle 110. Thus, the above configuration suppresses a decrease in user-friendliness for user U. Moreover, the charging timing and the charging location are determined so as to reduce the peak demand in the predicted electric power demand, and thus the above configuration can balance the supply and demand of electric power. Accordingly, recommended action output system 100 can balance the supply and demand of electric power while maintaining user-friendliness for its user.

Predictor 122a sets a time range in which the amount of electric power demand is lower than or equal to a threshold value in the change over time in electric power demand as a first time range in which charging is recommended. Determiner 122b determines the charging timing and the charging location based on the location of vehicle 110 in the first time range as determined based on the activity plan information, the amount of electricity stored in the storage battery of vehicle 110 in the first time range as determined based on the electricity storage information, and the charger information.

With this configuration, determiner 122b determines the charging timing to fall within the first time range, and thus the above configuration can balance the supply and demand of electric power effectively.

The activity plan information includes information indicating a destination of user U. Predictor 122a predicts a traveling route of vehicle 110 based on the current location of vehicle 110 and the destination, and determiner 122b determines the charging timing and the charging location based further on the traveling route.

With this configuration, user U can charge vehicle 110 not only at a charging location around the destination but also at a charging location around the traveling route, and thus this configuration gives more flexibility to determiner 122b in determining the charging timing and the charging location.

Communicator 121 obtains history information of the location of vehicle 110. Predictor 122a predicts an activity plan of user U based on the history information of the location of vehicle 110, and determiner 122b determines the charging timing and the charging location based on the predicted activity plan of user U.

This configuration allows determiner 122b to determine the charging timing and the charging location without having to obtain the activity plan of user U from user U. In other words, user U can obtain recommendation information without having to input his or her activity plan into information terminal 130 or the like. Accordingly, server device 120 can further suppress a decrease in user-friendliness for user U.

The charger information includes operation information indicating the operation state of corresponding vehicle charger 141. Determiner 122b determines the charging timing and the charging location based on the location of vehicle 110 in the first time range and the operation information.

With this configuration, the charging location is determined to a charging location with a low rate of operation included in the operation information, and thus user U can charge vehicle 110 with little waiting time upon arriving at the charging location indicated by the recommendation information. Accordingly, server device 120 can further suppress a decrease in user-friendliness for user U.

The charger information includes availability information indicating whether corresponding vehicle charger 141 is available for user. Determiner 122b identifies, from among a plurality of vehicle chargers 141, one or more vehicle chargers 141 available for use in the first time range based on the availability information and determines the charging timing and the charging location based on identified one or more vehicle chargers 141.

This configuration allows the charging location to be determined from one or more vehicle chargers 141 that are available for use in the first time range. In other words, the above configuration offer higher reliability for user U to be able to charge vehicle 110 upon arriving at the charging location that is based on the recommendation information. For example, the above configuration can reduce the likelihood that vehicle charger 141 is out of service due to a mechanical problem or the like when user U arrives at the charging location and user U has to go to a different charging location, and thus server device 120 can even further suppress a decrease in user-friendliness for user U.

Predictor 122a sets a time range in which the amount of electric power demand is higher than the threshold value in the change over time in electric power demand as a second time range in which discharging is recommended. Communicator 121 further outputs recommendation information recommending that vehicle 110 be not charged in the second time range.

This configuration allows server device 120 to keep user U from charging vehicle 110 in the second time range, and can thus balance the supply and demand of electric power more easily.

Vehicle charger 141 is a charger-discharger capable of charging and discharging. Predictor 122a sets a time range in which the amount of electric power demand is higher than the threshold value in the change over time in electric power demand as a second time range in which discharging is recommended, and communicator 121 further outputs recommendation information recommending that the storage battery of vehicle 110 be discharged in the second time range.

This configuration can reduce actual electric power demand in the second time range, and thus server device 120 can further balance the supply and demand of electric power. Moreover, as the storage battery is discharged in the time range that includes the time when the demand reaches its peak in the second time range, for example, server device 120 can balance the supply and demand of electric power effectively.

Determiner 122b determines a plurality of sets of charging timings and charging locations, and communicator 121 outputs recommendation information including the plurality of sets of charging timings and charging locations.

This configuration allows determiner 122b to propose a plurality of charging timings and charging locations to user U. User U can select a desired charging timing and a desired charging location from the plurality of sets of charging timings and charging locations included in the recommendation information.

The recommendation information includes information indicating the order of priority of the plurality of sets of charging timings and charging locations that is based on the degree to which each of the plurality of sets of charging timings and charging locations reduces the peak demand.

With this configuration, server device 120 sets the order of priority of a charging timing and a charging location higher as the degree to which the peak demand is reduced is higher, and thus server device 120 can reduce the peak demand more effectively. In other words, server device 120 can balance the supply and demand of electric power more easily.

As described above, the recommended action output method includes: obtaining activity plan information that includes an activity plan of user U of vehicle 110 provided with a storage battery (S11); obtaining electricity storage information that includes an electricity storage capacity of the storage battery of vehicle 110 and an amount of electricity stored currently in the storage battery (S12); obtaining charger information that includes the location of vehicle charger 141 installed in a specific area (S13); predicting a change over time in electric power demand in the specific area (S14); determining a charging timing of the storage battery of vehicle 110 to be recommended to user U and a charging location indicating the location of vehicle charger 141 for charging the storage battery so as to reduce the peak demand in the predicted change over time in the electric power demand, based on the activity plan information, the electricity storage information, and the charger information (S17); and outputting recommendation information that includes the determined charging timing and charging location (S19). As described above, a recording medium is a non-transitory computer-readable recording medium having a program recorded thereon, and the program causes a computer to execute the recommended action output method above.

The recommended action output method and the recording medium provide advantageous effects similar to those provided by recommended action output system 100 described above.

### Other Embodiments

Thus far, the recommended action output system and the recommended action output method according to the present disclosure have been described based on the foregoing embodiment, but the present disclosure is not limited to the foregoing embodiment.

For example, in the example described according to the foregoing embodiment, whether to charge vehicle 100 is determined based on the predicted amount of stored electricity, but this is not a limiting example. For example, whether to charge vehicle 110 may be determined based on the amount of stored electricity (the amount of electricity stored at the time when the vehicle transmits vehicle information) included in the electricity storage information obtained at step S12 of FIG. 6.

In the example described according to the foregoing embodiment, the server device is constituted by a single device. Alternatively, the server device may include a plurality of devices. In a case where the server device includes a plurality of devices, the functions of the server device may be distributed over the plurality of devices in any manner. At least a part of the functions of the server device according to the foregoing embodiment and so on may be included in a device or an information terminal owned by a collection agency.

There is no particular limitation on the method of communication between the devices in the recommended action output system according to the foregoing embodiment. The devices communicate with each other wirelessly in the examples described above. Alternatively, the devices may communicate with each other via cables. The devices may also communicate with each other through a combination of wireless communication and wired communication.

The order of the plurality of processes described in the foregoing embodiment is merely an example. The order of the plurality of processes may be modified, or at least a part of the plurality of processes may be executed in parallel.

The divisions of the functional blocks in the block diagrams are merely examples. A plurality of functional blocks may be implemented as a single functional block, a single functional block may be divided into a plurality of functional blocks, or some of the functions may be transferred to another functional block. The functions of a plurality of functional blocks having similar functions may be processed in parallel or through time sharing by a single piece of hardware or software.

In the foregoing embodiment, the constituent elements may each be implemented by a dedicated piece of hardware or may each be implemented through execution of a software program suitable for the corresponding constituent element. Each of the constituent elements may be implemented as a program executing unit, such as a processor, reads out a software program recorded on a recording medium, such as a hard disk or a semiconductor memory, and executes the software program. The processor is constituted by one or more electronic circuits including a semiconductor integrated circuit (IC) or a large scale integration (LSI) circuit. A plurality of electronic circuits may be integrated into a single chip or provided in respective chips. A plurality of chips may be integrated into a single device or provided in respective devices.

A system LSI circuit is an ultra-multifunctional LSI circuit manufactured by integrating a plurality of processors on a single chip, and is specifically a computer system that includes, for example, a microprocessor, a read only memory (ROM), or a random access memory (RAM). The ROM stores a computer program. The microprocessor operates in accordance with the computer program, and thus the system LSI circuit implements its functions.

Although a system LSI circuit is illustrated above, depending on the difference in the degree of integration, such a circuit may also be called an IC, an LSI circuit, a super LSI circuit, or an ultra LSI circuit. The technique for circuit integration is not limited to LSI, and an integrated circuit may be implemented by a dedicated circuit or a general purpose processor. A field programmable gate array (FPGA) that can be programmed after an LSI circuit is manufactured or a reconfigurable processor in which the connection or the setting of the circuit cell within an LSI circuit can be reconfigured may also be used.

Furthermore, when a technique for circuit integration that replaces LSI appears through the advancement in the semiconductor technology or through a derived different technique, the functional blocks may be integrated by use of such different techniques. An application of biotechnology is a possibility.

According to the foregoing embodiment, general or specific aspects of the above may be implemented in the form of a system, a method, an integrated circuit, a computer program, or a non-transitory computer-readable recording medium, such as a CD-ROM, or through any desired combination of a system, a method, an integrated circuit, a computer program, and a recording medium. The program may be a computer program that causes a computer to execute each characteristic step included in the recommended action output method.

An embodiment of the present disclosure may be a non-transitory computer-readable recording medium having such a program recorded thereon. For example, such a program may be recorded on a recording medium, which then may be distributed. For example, a distributed program can be installed onto a device including another processor, and the program can be executed by this processor. Thus, the device can perform each process described above. The program may be stored in advance in a recording medium or supplied to a recording medium via a broadband communication network including the internet.

Aside from the above, an embodiment obtained by making various modifications that a person skilled in the art can conceive of to the foregoing embodiment or an embodiment achieved by combining, as desired, the constituent elements and the functions according to the embodiment within the scope that does not depart from the spirit of the present invention is also encompassed by the present disclosure.

1. A recommended action output system comprising:
a first obtainer that obtains activity plan information including an activity plan of a user of a vehicle that includes a storage battery;
a second obtainer that obtains electricity storage information including an electricity storage capacity of the storage battery of the vehicle and an amount of electricity stored currently in the storage battery;
a third obtainer that obtains charger information including location of at least one vehicle charger installed in a specific area;
a predictor that predicts a change over time in electric power demand in the specific area;
a determiner that determines a charging timing of the storage battery to be recommended to the user and a charging location indicating a location of a vehicle charger for charging the storage battery so as to reduce peak demand in the change over time predicted in the electric power demand, based on the activity plan information, the electricity storage information, and the charger information; and
an outputter that outputs recommendation information including the charging timing and the charging location determined.

2. The recommended action output system according to claim 1, wherein
the predictor sets a time range in which an amount of electric power demand is lower than or equal to a threshold value in the change over time in the electric power demand as a first time range in which charging is recommended, and
the determiner determines the charging timing and the charging location based on a location of the vehicle in the first time range indicated by the activity plan information, an amount of electricity stored in the storage battery of the vehicle in the first time range indicated by the electricity storage information, and the charger information.

3. The recommended action output system according to claim 1, wherein
the activity plan information includes information indicating a destination of the user,
the predictor predicts a traveling route of the vehicle based on a current location of the vehicle and the destination, and
the determiner determines the charging timing and the charging location based further on the traveling route.

4. The recommended action output system according to claim 1, wherein
the first obtainer obtains history information of locations of the vehicle,
the predictor predicts an activity plan of the user based on the history information, and
the determiner determines the charging timing and the charging location based on the activity plan predicted.

5. The recommended action output system according to claim 2, wherein
the charger information includes operation information indicating an operation state of the at least one vehicle charger, and
the determiner determines the charging timing and the charging location based on the location of the vehicle in the first time range and the operation information.

6. The recommended action output system according to claim 2, wherein
the charger information includes availability information indicating whether the at least one vehicle charger are available for use,
the at least one vehicle charger includes a plurality of vehicle chargers, and
the determiner identifies, from among the plurality of vehicle chargers, one or more vehicle chargers available for use in the first time range based on the availability information, and determines the charging timing and the charging location based on the one or more vehicle chargers identified.

7. The recommended action output system according to claim 1, wherein
the predictor identifies a time range in which an amount of electric power demand in the change over time in the electric power demand is greater than a threshold value as a second time range, and
the outputter outputs the recommendation information further recommending that the vehicle be not charged in the second time range.

8. The recommended action output system according to claim 1, wherein
the vehicle charger is a charger-discharger capable of charging and discharging,
the predictor identifies a time range in which an amount of electric power demand in the change over time in the electric power demand is greater than a threshold value as a second time range in which discharging is recommended, and
the outputter outputs the recommendation information further recommending that the storage battery of the vehicle be discharged in the second time range.

9. The recommended action output system according to claim 1, wherein
the determiner determines a plurality of sets of the charging timing and the charging location, and
the outputter outputs the recommendation information including the plurality of sets of the charging timing and the charging location.

10. The recommended action output system according to claim 9, wherein
the recommendation information includes information indicating an order of priority of the plurality of sets of the charging timing and the charging location, the order of priority being based on a degree to which each of the plurality of sets reduces the peak demand.

11. A recommended action output method comprising:
obtaining activity plan information including an activity plan of a user of a vehicle that includes a storage battery;
obtaining electricity storage information including an electricity storage capacity of the storage battery of the vehicle and an amount of electricity stored currently in the storage battery;
obtaining charger information including locations of a plurality of vehicle chargers installed in a specific area;
predicting a change over time in electric power demand in the specific area;
determining a charging timing of the storage battery to be recommended to the user and a charging location indicating a location of a vehicle charger for charging the storage battery so as to reduce peak demand in the change over time predicted in the electric power demand, based on the activity plan information, the electricity storage information, and the charger information; and
outputting recommendation information including the charging timing and the charging location determined.

12. A non-transitory computer-readable recording medium having a program recorded thereon, the program causing a computer to execute the recommended action output method according to claim 11.
